(19) United States
(12) Patent Application Publication
(10) Pub. No.: US 2003/0225580 A1
(43) Pub. Date: Dec. 4, 2003

(54) User interface, system, and method for automatically labelling phonic symbols to speech signals for correcting pronunciation

(76) Inventor: Yi-Jing Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,616

(22) Filed: Jul. 31, 2002

(30) Foreign Application Priority Data
May 29, 2002 (TW) 91111432

(51) Int. Cl. G10L 15/04

(52) U.S. Cl. 704/254

(57) ABSTRACT

A user interface, a system and a method are provided to automatically compare the speech signal of a language learner against that of a language teacher. The system labels the input speech signals with phonic symbols and identifies the portions where the difference is significant. The system then gives grades and suggestions to the learners for improvement. The comparison and suggestions include articulation correctness, timing, pitch, intensity, etc. The method comprises three major stages. In the first stage, a phoneme-feature database is established. The phoneme-feature database contains the statistic data of phonemes. In the second stage, the speech signals of a language learner and a language teacher are labeled with phonic symbols that represent phonemes. In the third stage, the corresponding sections in the student and teachers' speech signals are identified and compared. Grades and suggestions for improvement are given on articulation correctness, timing, pitch, intensity, etc.

### CROSS REFERENCE TO RELATED APPLICATIONS

This application claims the priority benefit of Taiwan application serial no. 91111432, filed May 29, 2002.

### BACKGROUND OF INVENTION

1. Field of the Invention

The present invention relates generally to interactive language learning systems using speech analysis. In particular, the present invention relates to a user interface, system, and method for teaching and correcting pronunciation on a computerized device. Still more particularly, the present invention relates to a user interface, system, and method for teaching and correcting pronunciation on a computerized device through a quick and effective assignment of phonic symbols to each component of speech signal.

2. Related Art of the Invention

In general pronunciation is the most challenging part of learning a foreign language. It is especially true for Asians learning an Indo-European language, and vice-versa. One can master skills such as reading, writing, and listening through self-studying. However, to be able to speak a foreign language well, the learner needs to know whether he or she is speaking correctly. Currently the most effective way to do so is to practice with native speakers who can identify the pronunciation errors and correct them appropriately. Our invention is targeted to help foreign language learners identify and improve their pronunciation through an interactive and technology-driven system which provides a proactive pronunciation correcting mechanism to closely mimic a real language tutor”s behavior.

Many corporations have developed related computer products for correcting pronunciation, such as CNN Interactive CD from Taiwan”s Hebron Corporation and TellMeMore from France”s Auralog Corporation. However, their current products only provide rudimentary voice comparison without telling the learner how to improve his or her pronunciation. Both products can record the learner”s voice and display the waveform to compare against the waveform produced by the native speaker.

However, the waveform comparison is not very meaningful to the learner. Even for an accomplished linguist, he or she cannot determine similarity between two pronunciations by simply comparing their waveforms. In addition, such systems can not locate the exact syllable in a sound signal. Thus, it cannot offer improvement suggestion to the learner on a syllable-by-syllable basis. Furthermore, such systems assume that the learner and the teacher speak at the same rate. In actuality, the speech timing is highly variable, dependent on the individual. It is possible that when the teacher is reading the fifth word, the learner is still reading the second. In this example, the waveform comparison will wrongly correspond the learner”s second word to that of the fifth word spoken by the teacher. It is clear that such comparison is flawed.

FIG. 1 illustrates an example of the above situation. FIG. 1 shows a user interface of the “TellMeMore” application produced by Auralog. The part denoted by 100 indicates the sentence which the learner was learning. The reference numerals 110 and 120 indicate the voice waveforms pronounced by the teacher and the learner, respectively. The application attempted to compare the pronunciation difference of the word “for” (the highlighted part t0-t1) spoken by the learner and the teacher. However, due to timing variation, the application failed to locate the position of the word “for” in both voice waveforms of the learner and the teacher. In fact, during the time interval t0-t1, the learner did not make any sound.

In sum, direct graphical waveform comparison without improvement suggestion and timing adjustment is not only ineffective, but meaningless.

### SUMMARY OF INVENTION

The present invention provides a system in a computer environment that automatically labels phonic symbols against learner”s voice waveform for error identification and subsequent pronunciation correction. In addition, the invention can automatically perform word alignment between the learner”s and teacher”s voice waveforms to further identify learning needs. The invention includes a user interface and a fabrication method for the system.

The user interface invention has at least three major improvements over other existing products. First, both learner and teacher”s waveforms are automatically labeled with corresponding phonic symbols. Thus, the learner can easily spot the difference between his or her voice and the teacher”s. Second, according to the phonic symbol of each interval the learner can locate the relative position of a specific word or syllable to be further extracted for comparison. Third, the comparison covers four skill areas of pronunciation: articulation accuracy, pitch, intensity, and rhythm. The learner can further use the information extracted from the voice signal from these four areas to adjust his or her overall pronunciation by trying to improve each skill area.

The fabrication and utilization methods can be divided into three stages; that is, the database establishing stage, the phonic symbol labeling stage, and the pronunciation comparison stage. During the first stage, the phoneme-feature database is to be established and it should include the feature data of each phoneme which is the minimum unit for phonetics, corresponding to a phonic symbol used as the basis for labeling phonic symbols. During the second stage, the objective is to label the phonic symbol to each interval of a sound wave. This process is applied to both the learner”s voice waveform and the teacher”s. Teacher”s voice wave is then served as a standard for later analysis. In the last stage, the two waveforms of teacher”s and learner”s are then compared to analyze the difference between corresponding intervals. The pronunciation of the learner is then graded and if necessary, suggestions for improvement are then provided. A detailed description for each of the stages is detailed as follows.

In the database establishing stage, a statically significant amount of voice samples needs to be collected. The voice samples, recorded from various foreign language teachers, comprise pronunciations of various sentences. The sample sound signals are then partitioned into a plurality of frames with constant length. A feature extractor is used to analyze and obtain the features of each frame. Classification is made by manual judgment to accumulate the sample frame attributed to the same phoneme into the same phoneme cluster. The mean value and standard deviation for each feature of each phoneme cluster are calculated and saved in the database.

In the phonic symbol labeling stage, input data required by the system include a text string and the recorded sound signal of the text string pronounced by the language teacher and the learner. The output in this stage includes a sound signal of which each interval is labeled with a phonic symbol. In the practical application, an electronic dictionary is used to look up the corresponding phonic symbols of the input text string. The input sound signal is then partitioned into a plurality of frames with constant length. The feature of each frame is calculated. Using the phoneme feature database, the possibility for each frame attributed to certain phonic symbol is calculated. A dynamic programming method and technique is then applied to obtain the optimal phonic symbol.

In the pronunciation comparison stage, the two sound signals labeled with the phonic symbols in the previous stage are compared. The sound signals normally come from the language teacher and learner. The corresponding portions (one or more frames) of both sound signals are found first and compared. For example, when the learner is learning the sentence “This is a book”, the system finds the “th” part in the sound signals from both the learner and the teacher first to make a comparison. The parts corresponding to “i” is then found for comparison, and the parts corresponding to “s” are found and compared accordingly. The comparing content includes, but is not limited to the articulation accuracy, pitch, intensity and rhythm. While comparing the articulation accuracy, the articulation of the learner is compared to that of the teacher directly. Or alternatively, the articulation of the learner can be compared to articulation data in the phoneme database. While comparing the pitch, the pronunciation of the learner can be compared to the absolute pitch of that of the teacher. Alternatively, the relative pitch (the ratio of the pitch of a part of a sentence to the average pitch of the whole sentence) of the learner can be calculated first, and compared to the relative pitch of the teacher. Similarly, for comparing the pronunciation intensity, the intensity of the learner can be compared to the absolute intensity of that of the teacher. Or one can calculate the relative pronunciation intensity at the part of the sentence (the ratio of the pronunciation intensity for this part to that of the whole sentence) to be compared to the relative pronunciation of the teacher at this part of the sentence. For the duration comparison, the pronunciation lengths at the part of the sentence of the learner and the teacher can be compared directly, or the relative pronunciation length of the learner can be calculated (the duration ratio for the length of this part to that of the whole sentence) first, followed by the comparison to that of the teacher.

Such comparison can be presented in a fraction or a probability percentage. By weighting calculation, the fractions for articulation accuracy, pitch, intensity, and rhythm of the whole sentence spoken by the learner can be obtained. The fraction for the whole sentence can also be obtained by the weighted average. While performing the weighted calculation, the weight for each part can be derived from logics or empirical values from research papers.

In the processes of fraction comparison and calculation, the system obtains the location and level of pronunciation difference between the learner and the teacher, so that an appropriate suggestion for improvement can be provided.

The user interface of the above system and method includes sound signal graph obtained from an audio input apparatus, and the intensity and pitch variation graphs obtained by analyzing sound signal. In addition, the sound signal graph is further segmented into a plurality of pronunciation intervals; each is labeled with a corresponding phonic symbol. The user can use an input apparatus such as a mouse to select one or more pronunciation intervals to play the sound of the pronunciation intervals individually.

In this system, the sound signals of the learner and the teacher are represented graphically. When the user selects a pronunciation interval from the teacher”s sound signal, the system automatically selects the corresponding pronunciation interval of the learner”s sound signal, and vice-versa.

### BRIEF DESCRIPTION OF DRAWINGS

FIG. 1 shows a user interface for articulation practice produced by the European company, Auralog Corp.;

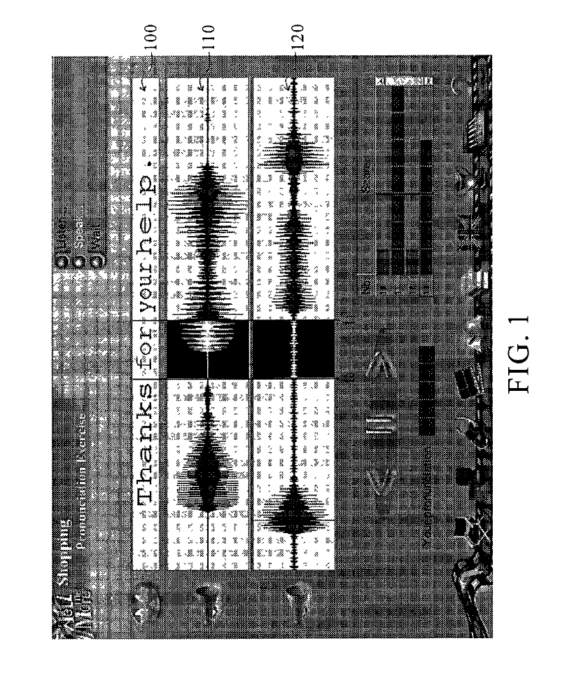

FIG. 2 shows one embodiment of a user interface of automatically labeling phonic symbols for correcting pronunciation according to the present invention;

FIG. 3 shows one embodiment of a user interface of automatically labeling phonic symbols for correcting pronunciation according to the present invention;

FIG. 4 shows a system block diagram for the database establishing stage in one embodiment of the present invention;

FIG. 5 shows a system block diagram for the phonic symbol labeling stage in one embodiment of the present invention;

FIG. 6 shows the process flow for the phonic symbol labeling stage;

FIG. 7 shows a schematic drawing of performing dynamic comparison in the phonic symbol labeling stage according to the present invention; and

FIG. 8 shows a system block diagram for the pronunciation comparison stage in one embodiment of the present invention.

### DETAILED DESCRIPTION

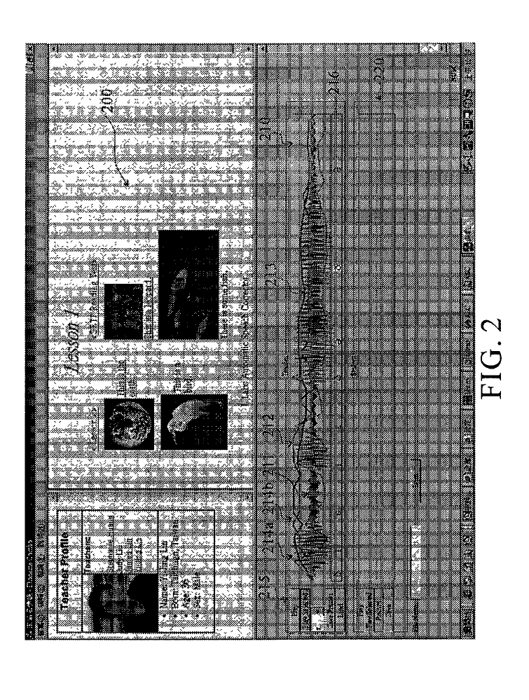

Referring to FIG. 2, an embodiment of a user interface is shown. The user interface includes three parts, that is, the teaching content display area 200, the teacher interface 210, and the learner interface 220.

When the user uses an input device such as a mouse to select a text string in the teaching content display area 200, the system plays the sound signal pre-recorded by the teacher corresponding to the selected text string and display the relative information in the teacher interface 210.

The teacher interface 210 includes a sound signal graph 211, a pitch variation graph 212, an intensity variation graph 213, a plurality of partition segments 214, a teacher command area 215, and a phonic symbol area 216. The sound signal graph 211 displays the waveform of the sound signal of the teacher. The intensity variation graph 213 is obtained by analyzing the energy variation of the sound signal. The pitch variation graph 213 is obtained by analyzing the pitch variation of the sound signal. The analyzing method can be referred to “An Optimum Processor Theory for the Central Formation of the Pitch of Complex Tones” proposed by Goldstein, J. S. in 1973, “Measurement of Pitch in Speech: An Implementation of Goldstein”s Theory of Pitch Perception” proposed by Duifhuis, H., Willems, L. F., and Sluyter R. J. in 1982, or “Speech and Audio Signal Processing” proposed by Gold, B., and Morgan N. in 2000.

In the teacher interface 210, the system uses the partition segments 214 to partition the sound wave graph into several pronunciation intervals, and label the corresponding phonic symbol for each of the pronunciation interval in the phonic symbol labeling area 216. For example, the pronunciation area between the partition segments 214a and 214b corresponds to the pronunciation of “I”, such that the phonic symbol thereof is displayed under the pronunciation area of the phonic labeling area 216. The user can use the input device such as the mouse to select one or several consecutive pronunciation areas. By clicking the play-selected icon of the user command area 215, the sound signal of the pronunciation area is played.

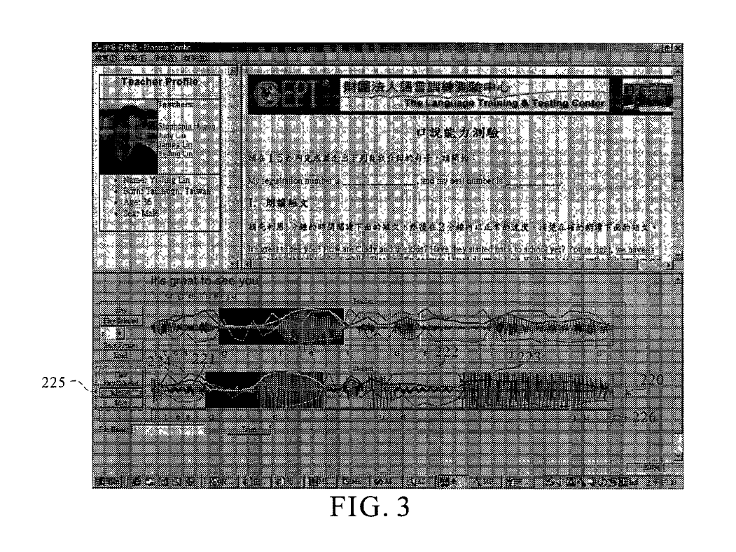

Similar to the teacher interface 210, the learner interface 220 includes a sound signal graph 221, a pitch variation graph 222, an intensity variation graph 223, several partition segments 224, and a phonic symbol labeling area 226. The functions similar to the teacher interface 210 as shown in FIG. 3 are not described again here. However, the sound signal to be analyzed is not pre-recorded. Instead, the sound signal is obtained by clicking the “record” icon displayed in the user command area 225 by the user.

As shown in FIG. 3, when the user selects a pronunciation interval in the learner interface 220, the system highlights the selected interval. According to the labeled phonic symbol, the corresponding pronunciation area in the teacher interface 210 is automatically selected and highlighted. In this embodiment, the timing for the learner and the teacher to speak the word “great” is different. However, the present invention is able to automatically and accurately label the position of the word in the sound signal graphs of both the learner and the teacher.

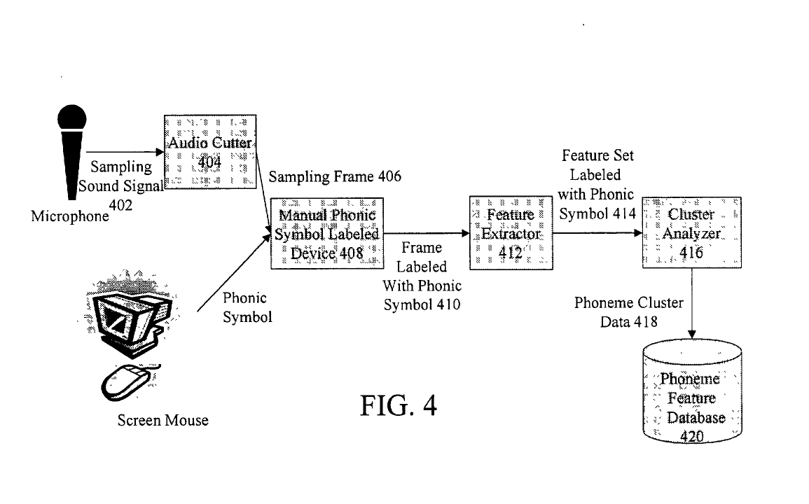

A detailed description of the embodiment is further introduced as follows. FIG. 4 shows the major module in the database establishing stage of the system. In this stage, the audio cutter 404 partitions the sample sound signal 402 into a plurality of sample frames 406 with a constant length (normally 256 or 512 samples and may be overlapping). A human expert will then listen to the frames and use a phonic symbol labeler 408 to assign phonic symbols to each sample frames 406 The labeled frames 410 are then fed to the feature extractor 412 to calculate their feature sets 414. The feature sets usually contains 5 to 40 real numbers, including Cepstrum coefficients or linear predictive coding coefficients. The technique for extracting features from an audio frame can be referred to “Comparison of Parametric Representations of Monosyllabic Word Recognition in Continuously Spoken Sentences” proposed by Davis, S. and Mermelstein, P. in 1980, or “Speech and Audio Signal Processing” proposed by Gold, B. and Morgan, N. in 2000.

The cluster analyzer 416 analyzes the feature sets of sample frames 414 and put similar frames into a cluster. For each of the phoneme clusters, the mean value and standard deviation of the feature sets are calculated. The cluster information 418 is then saved in the phoneme feature database 420. The technique for cluster analysis can be referred to the book “Pattern Classification and Scene Analysis” authored by Duda, R. and Hart, P. and published by Wiley-Interscience in 1973.

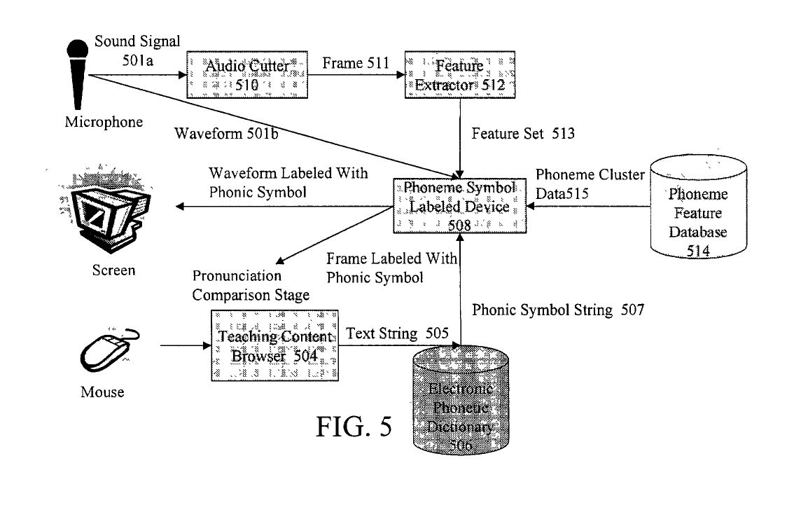

FIG. 5 shows the major module in the phonic symbol labeling stage in one embodiment of the present invention. In this stage, one of the objectives is to assign the correct phonic symbol to each interval of a sound signal and display the phonic symbol on the teacher interface 210 and the learner interface 220. Meanwhile, the result is fed to the pronunciation comparator (not shown) in the pronunciation comparison stage for grading. The system requires two input information in the phonic symbol labeling stage; one is the text string selected from the content browser 504 by the user, and the other one is the corresponding sound signal 501a.

The sound signal 501a is partitioned into multiple frames 511 in the same length by the audio cutter 510. The feature extractor 512 is used to calculate the feature set 513 of each frame 511. The functions of the audio cutter 510 and the feature extractor 512 are the same as in the previous stage and are not further described.

The text string 505 selected from the teaching content browser 504 is converted into a phonic symbol string 507 via an electronic phonetic dictionary 506. For example, when the text string “This is good” is selected by the user, the text string is converted into a phonic symbol string “ [symbol] Is Iz gUd”.

The phonic symbol labeler 508 takes the waveform graph 501b, the feature sets of frames 513, the phonic symbol string 507, and the phoneme data 515 from the phoneme-feature database 514 as inputs to label the phonic symbols onto the audio signal. The result is sent to the output interface as a waveform graph labeled with phonic symbols.

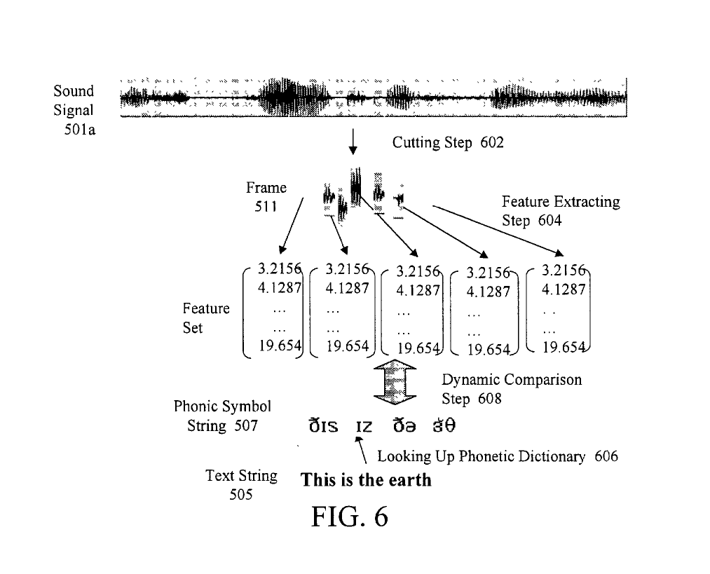

In FIG. 6, an example is used to explain the phonic symbol labeling process. First, the sound signal 601a is partitioned into a plurality of frames 611 by the audio cutter in step 602. Second, a feature set is extracted from each frame by the feature extractor in step 604. Third, the string of phonic symbols 607 corresponding to the input text string 605 is obtained in step 606 by looking up the phonic dictionary. Finally, we compare the feature sets of sample frames and the string of phonic symbols in step 608 and assign a phonic symbol to each frame.

The labeling process has to meet the following requirements. First, the phonic symbols should be used in the same order as they appear in the input phonic string. Second, each phonic symbol may correspond to zero, one or multiple consecutive frames. (If a phonic symbol does not correspond to any frame, it indicates that that phonic symbol is not pronounced). Third, each frame can correspond to zero or one phonic symbol. (If a frame does not correspond to any phonic symbol, then it corresponds to a blank or a noise in the sound signal). Fourth, The label has to maximize a pre-defined utility function (or minimize a pre-defined penalty function). The utility function indicates the correctness of the labeling (while the penalty function indicates the error of the label). The utility and penalty functions can be derived by theoretical or empirical studies.

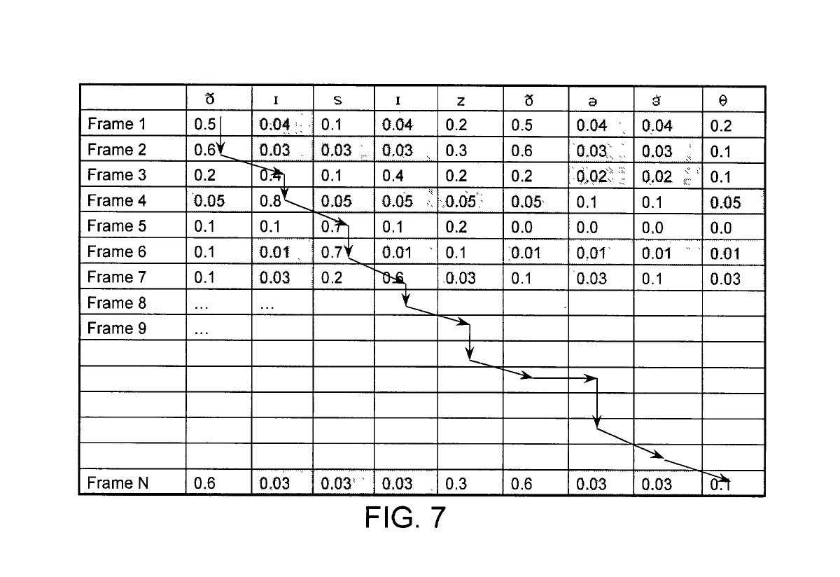

The table in FIG. 7 illustrates how this labeling process can be carried out with dynamic programming techniques. In this table, each row corresponds to a frame of the input speech signal and each column corresponds to a phonic symbol in the input phonic string. The cell at row i and column j contains the value of:

max (Prob (frame i belong to the phoneme represented by phonic symbol j), Prob (frame i is a silence or noise)) The probability values in this equation can be calculated by comparing the feature set of the frame i against the data in the phoneme-feature database. Methods of calculating these probability values can be found in “Pattern Classification and Scene Analysis” by Duda, R. and Hart, P., published by Wiley-Interscience in 1973.

In addition, we will mark all the cells whose values come from the probability that they are noise or blank. In FIG. 7, all these cells are marked with gray background.

With such a table in place, labeling the speech signal will correspond to finding a path from the upper left corner to the lower right corner. For example, the path in FIG. 7 represents a labeling that the first phonic symbol “ [symbol] ” corresponds to frames 1 and 2; the second phonic symbol “i” corresponds to frames 3 and 4; and the third phonic symbol “s” corresponds to frames 5 and 6.

A path that represents an optimal labeling has to meet two requirements. First, the path can only extend towards the right, the lower right, or go downwardly. Second, the labeling represented by this path should maximize our utility function.

If the path travels through a gray cell, then the corresponding frame is a noise or a blank. Otherwise, if the path extends toward the right, it indicates that the following phonic symbol does not appear in the sound signal. If the path extends towards the lower right, it indicates that the next frame corresponds to the next phonic symbol. If the path extends downwardly, it indicates that the next frame corresponds to the same phonic symbol as the current frame does.

In this embodiment, the utility function can be defined as the multiplication of all the values in the cells passed by a path, except the cells that are passed when the path is extending toward the right. (If the path is extending toward the right, the phonic symbol is skipped and thus the value in the cell should not be used in the calculation. Theoretically, the result of the multiplication represents the probability that the labeling is correct.

Such a path can be obtained by dynamic programming. The relevant technique can be found in “A Binary n-gram Technique for Automatic Correction of Substitution, Deletion, Insertion, and Reversal Errors in Words” by J. Ullman in Computer Journal 10, pp141-147, 1977, or “The String to String Correction Problem” disclosed by R. Wagner and M. Fisher in Journal of ACM 21, pp168-178, 1974.

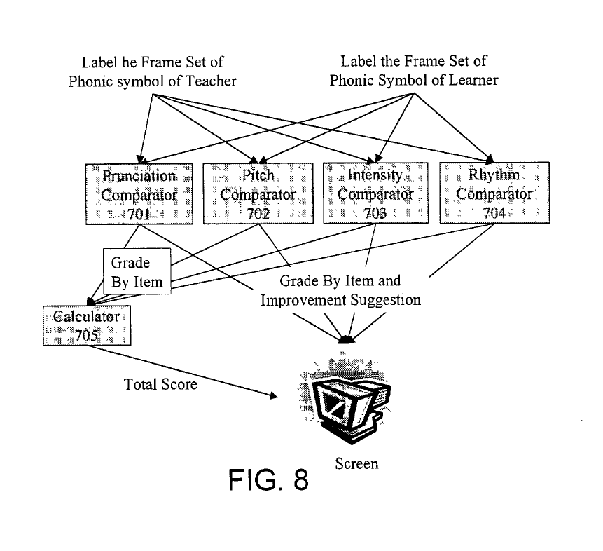

FIG. 8 illustrates the major module in the pronunciation comparison stage of the system. In this stage, the system grades articulation accuracy, pitch, intensity, and rhythm and lists the suggestion for improvement. These four grades are then used to calculate a weighted average as the total score. The weight of each grade can be derived from theory or empirical data.

During the pronunciation comparison stage, the system will locate and compare the corresponding sections, which consist one or more frames, in the two input audio signals. For example, if the learner is learning the sentence “This is a book”, the system will locate and compare the sections corresponds to “Th” in the learner and the teachers' sound signals. Then the system will locate and compare the sections correspond to “i”. Then the system will locate and compare the sections correspond to “s”, and so on. The comparison of each section will include the articulation accuracy, pitch, intensity, and rhythm, etc.

If a phonic symbol (or syllable) in one sound signal corresponds to multiple frames, then the mean value of the feature sets of these frames is obtained (for comparing articulation, pitch, intensity and length). The corresponding mean value of the other sound signal is then obtained for comparison. We can also compare individual frames in the corresponding sections to analyze the variation in articulation, pitch and intensity over time.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. A method of automatically labeling an speech signal with phonic symbols for correcting pronunciation, comprising:
A step of establishing a phoneme-feature database, including using sample sound signal to establish a plurality of phoneme clusters;
A step of phonic symbol labeling, comprising:
Partitioning one sound signal into a plurality of frames, and calculating a feature set for each frame; and
Determining the phoneme cluster to which each frame belongs and labeling the frame with the corresponding phonic symbol; and
A step of pronunciation comparison, which compares the frames of two sound waves corresponding to the same phonic symbol or syllable, and perform grading and providing suggestion for improvement.

2. The method according to claim 1, wherein the step of establishing the phoneme-feature database further comprises analyzing the sample frames corresponding to each of the phoneme clusters.

3. The method according to claim 2, wherein the step of establishing the phoneme-feature database further comprises:
Recording sample sound signals;
Partitioning each sample sound signal into a plurality of sample frames;
Determining a phoneme cluster that each sample frame belongs to;
Calculating the feature set of each sample frame; and
Calculating the mean and variance of the feature sets of each phoneme cluster.

4. The method according to claim 2, further comprising the step of determining the phoneme cluster to which each frame belongs.

5. The method according to claim 2, wherein data contained in each phoneme cluster comprises the mean and variance of all the sample frames belong to the phoneme.

6. The method according to claim 1, wherein the step of phonic symbol labeling comprises:
Inputting a text string and a corresponding sound signal;
Looking up an electronic phonetic dictionary to find a string of phonic symbols that corresponds to the input text string;
Partitioning the input sound signal into a plurality of frames;
For each frame, calculating the probabilities that the frame belongs to different phonemes by comparing the frame's feature set against the data in the phoneme-feature database;
Obtaining an optimum labeling to frames that maximize the probability that the labeling is correct;
Displaying the phonic symbol corresponding to each frame.

7. The method according to claim 6, further comprising comparing the input text string and the corresponding input sound signal to obtain the label phonic symbol.

8. The method according to claim 6, when some of the phonic symbols corresponding to the input text string do not appear in the input sound signal, a normal operation is maintained, and other phonic symbols are used for labeling.

9. The method according to claim 6, when some intervals of the input sound signal contains silence, noise, or is redundant and does not correspond to any portion of the input text string, a normal operation is maintained, and other intervals of the sound signal are labeled.

10. The method according to claim 6, wherein the step of obtaining the optimum labeled phonic symbol includes a dynamic programming technique.

11. The method according to claim 10, wherein the dynamic programming technique includes using a comparison table, of which a row (or column) corresponds to a phonic symbol of the input phonic string, and a column (or row) corresponds to a frame in the input sound signal.

12. The method according to claim 11, wherein the step of obtaining the optimum labeling includes finding a path extending from upper left to lower right (or from lower right to upper left) which maximizes a predetermined utility function (or minimizes a predetermined penalty function).

13. The method according to claim 1, wherein in the pronunciation comparison stage, one of the two sound signals is pre-recorded, and the other sound signal is recorded in real time.

14. The method according to claim 1, wherein the step of pronunciation comparison stage comprises comparing articulation accuracy, pitch, intensity and timing (rhythm).

15. A user interface for automatically labeling speech signals with phonic symbols for correct pronunciation, comprising:
Waveform graphs, obtained by analyzing the sound signals;
Intensity variation graphs, obtained by analyzing the sound signals;
Pitch variation graphs, obtained by analyzing the sound signals;
Multiple pronunciation intervals on the waveform, intensity variation, and pitch variation graphs, where each interval corresponds to a phonic symbol and is bounded by two partitioning line segments; and
Phonic symbol labeling areas, which display the phonic symbols corresponding to the pronunciation intervals.

16. The user interface according to claim 15, where a user can select one or multiple adjacent pronunciation intervals and click a button or issue a command to replay the sound of those selected intervals.

17. The user interface according to claim 16, in which if one or more adjacent pronunciation intervals in the teacher's (or student's) speech signal are selected, the corresponding pronunciation intervals in the student's (or teacher's) speech signal will be selected automatically.

18. A system for automatically labeling speech signals with phonic symbols to correct a language learner's pronunciation, comprising:
An input device, to input a text string and a corresponding sound signal;
An electronic phonetic dictionary, which is used to look up the string of phonic symbols that correspond to a text string;
An audio cutter that partitions the sound signals into multiple frames. The frames may be overlapping;
A feature extractor, which extract a set of features from each frame;
A phoneme-feature database, including multiple phoneme clusters, where each of the phoneme clusters corresponds to a phonic symbol;
A phonic symbol labeler, which labels intervals of a speech signal with phonic symbols; and
An output device, which displays a waveform graph, a pitch variation graph, an intensity variation graph and phonic symbols corresponding to each pronunciation interval of the input sound signals.
